(19) United States
(12) Patent Application Publication
(10) Pub. No.: US 2026/0310118 A1
(43) Pub. Date: Oct. 8, 2026

(54) IMAGE FORMING APPARATUS

(71) Applicant: CANON KABUSHIKI KAISHA, Tokyo (JP)

(72) Inventor: MITSURU YAMATANI, Ibaraki (JP)

(21) Appl. No.: 19/576,261

(22) Filed: Mar. 24, 2026

(30) Foreign Application Priority Data
Apr. 4, 2025 (JP) 2025-062173

(51) Int. Cl. G03G 15/16; G03G 15/00; G03G 21/08; G03G 21/16

(52) U.S. Cl. CPC G03G 15/161; G03G 15/5041; G03G 15/5058; G03G 21/08; G03G 21/1671; G03G 21/168; G03G 2221/0005; G03G 2221/1606; G03G 2221/1642

(57) ABSTRACT

An image forming apparatus for forming an image on a recording material is provided. The control unit of the image forming apparatus is configured to execute a first mode in which the toner image formed on the image bearing member is transferred to the intermediate transfer member and further transferred to the recording material and a second mode in which the adjustment toner image is formed on the image bearing member and detected by the detection unit. The control unit is configured to apply a transfer voltage having a polarity opposite to a normal charging polarity of the toner to the transfer member at least while the adjustment toner image passes through the primary transfer portion, transfer the adjustment toner image to the intermediate transfer member, and rotate the intermediate transfer member such that the transferred adjustment toner image passes through the cleaning unit, during execution of the second mode.

### BACKGROUND

### FIELD OF THE TECHNOLOGY

The present disclosure relates to an image forming apparatus using an electrophotographic technology, such as a printer, a copier, a facsimile machine, or a multifunction peripheral.

### DESCRIPTION OF THE RELATED ART

In an image forming apparatus, an adjustment toner image (referred to as a patch) is formed, the density of the formed patch is detected, and an image forming condition is changed according to the density of the patch, thereby adjusting the density of a toner image to be formed on a recording material. In JP 2015-222406 A, in a full-color mode, a patch formed on a photosensitive drum is transferred to an intermediate transfer belt, and the density of the patch transferred to the intermediate transfer belt is detected by an on-belt patch sensor. The patch formed on the intermediate transfer belt is removed by a belt cleaning device. In the case of a black monochrome mode, the patch is not transferred from the photosensitive drum to the intermediate transfer belt, and the density of the patch formed on the photosensitive drum is detected by an on-drum patch sensor. The patch formed on the photosensitive drum is removed by a drum cleaning device.

There is a case where the image forming apparatus includes a pre-exposure device that neutralizes the surface of the photosensitive drum before charging the surface of the photosensitive drum uniformly. The pre-exposure device neutralizes the photosensitive drum at a position upstream of the drum cleaning device in a rotation direction of the photosensitive drum (which is referred to as pre-exposure). However, hitherto, in a case where the pre-exposure device is provided, there is a possibility that toner scattering from the patch on the photosensitive drum occurs due to the neutralization of the photosensitive drum on which the patch is formed, and the scattered toner adheres to and contaminates the photosensitive drum, the pre-exposure device, or the like.

### SUMMARY

The present disclosure has been made in view of the above problems, and the present disclosure provides an image forming apparatus capable of suppressing toner scattering caused by neutralization of a photosensitive drum after detecting a density of a patch formed on the photosensitive drum.

According to a first aspect of the present disclosure, an image forming apparatus configured to form an image on a recording material is provided. The image forming apparatus include a rotatable image bearing member, a charging unit configured to charge the image bearing member, an exposure unit configured to expose the charged image bearing member to form an electrostatic latent image, a developing unit configured to develop the electrostatic latent image formed on the image bearing member into a toner image at a developing position, an intermediate transfer member configured to receive the toner image from the image bearing member and transfer the toner image to the recording material, a transfer member configured to form a primary transfer portion for transferring the toner image formed on the image bearing member to the intermediate transfer member and transfer the toner image by application of a transfer voltage, a detection unit configured to detect a density of an adjustment toner image formed on the image bearing member at a position downstream of the developing position and upstream of the primary transfer portion in a rotation direction of the image bearing member, a neutralization unit configured to neutralize a surface of the image bearing member by irradiating light at a position downstream of the primary transfer portion in the rotation direction and upstream of the charging unit in the rotation direction, a cleaning unit configured to remove toner on the intermediate transfer member at a position upstream of the primary transfer portion and downstream of a secondary transfer portion for transferring the toner image from the intermediate transfer member to the recording material in a rotation direction of the intermediate transfer member, and a control unit configured to execute a first mode in which the toner image formed on the image bearing member is transferred to the intermediate transfer member and is transferred from the intermediate transfer member to the recording material and a second mode in which the adjustment toner image is formed on the image bearing member and detected by the detection unit. The control unit is configured to apply a transfer voltage having a polarity opposite to a normal charging polarity of the toner to the transfer member at least while the adjustment toner image passes through the primary transfer portion, transfer the adjustment toner image to the intermediate transfer member, and rotate the intermediate transfer member such that the transferred adjustment toner image passes through the cleaning unit, during execution of the second mode.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating an image forming apparatus of the present embodiment.

FIG. 2 is a schematic diagram illustrating the image forming apparatus in a black monochrome mode.

FIG. 3 is a schematic diagram illustrating a patch sensor.

FIG. 4 is a schematic diagram illustrating a pre-exposure device.

FIG. 5 is a cross-sectional view illustrating an example of a layer configuration of an intermediate transfer belt.

FIG. 6 is a schematic diagram illustrating a belt cleaning device.

FIG. 7 is a graph illustrating a signal value of the patch sensor.

FIG. 8A is a schematic diagram illustrating an example of a patch used in an adjustment mode period.

FIG. 8B is a schematic diagram illustrating an example of an automatic toner replenishment (ATR) patch used in an ATR control period.

FIG. 9 is a block diagram illustrating a control system of the image forming apparatus.

FIG. 10A is a schematic diagram for describing toner scattering from the patch and illustrates a state of the patch before pre-exposure.

FIG. 10B is a schematic diagram for describing the toner scattering from the patch and illustrates a state of the patch during the pre-exposure.

FIG. 11 is a flowchart illustrating density adjustment processing of the present embodiment.

FIG. 12A is a diagram illustrating sequences of Embodiment 1 and Comparative Example 2.

FIG. 12B is a diagram illustrating a sequence of Comparative Example 1.

FIG. 12C is a diagram illustrating a sequence of Embodiment 2.

FIG. 13 is a diagram for describing an effect of the present embodiment.

### DESCRIPTION OF THE EMBODIMENTS

Hereinafter, embodiments of the present disclosure will be described in detail with reference to the drawings.

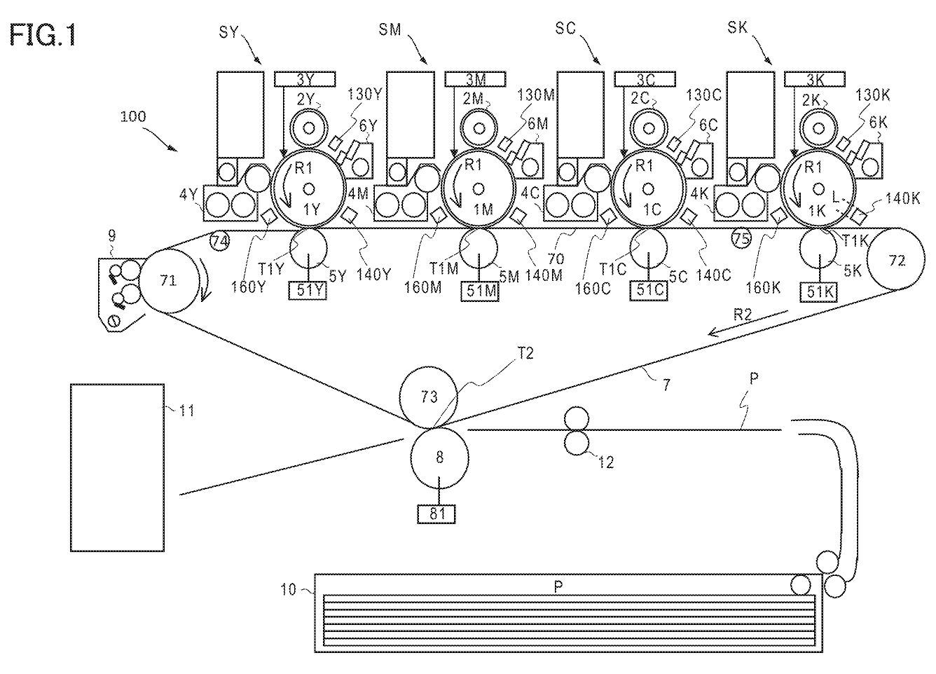

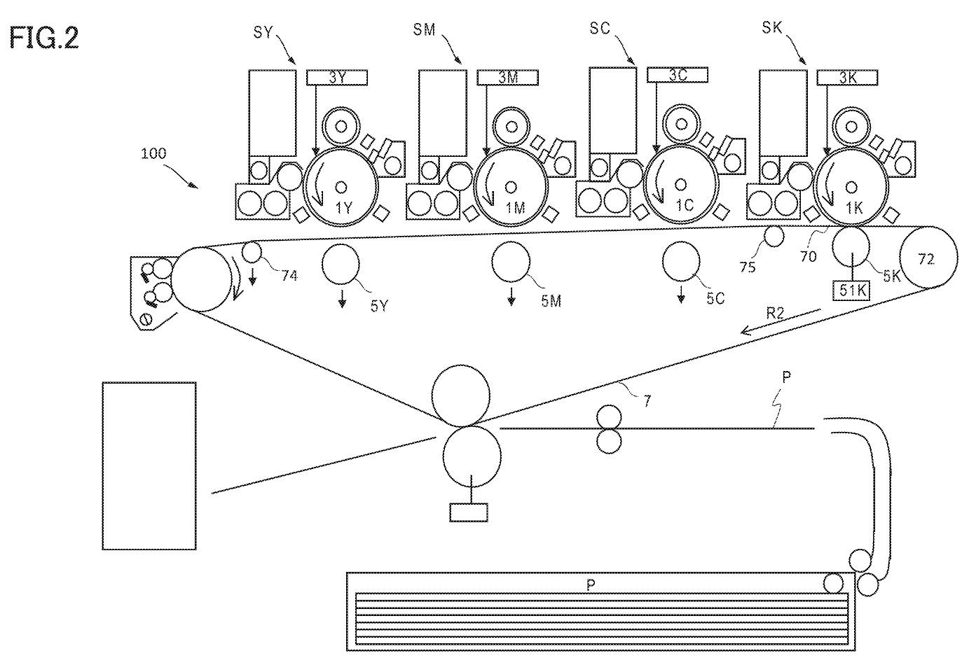

First, an image forming apparatus of the present embodiment will be described with reference to FIGS. 1 and 2. FIG. 1 is a schematic diagram of the image forming apparatus of the present embodiment. FIG. 2 is a schematic diagram illustrating the image forming apparatus in a black monochrome mode. An image forming apparatus 100 of the present embodiment is a tandem laser beam printer adopting an intermediate transfer method, which is capable of forming a full-color image on a recording material using an electrophotographic system.

As illustrated in FIG. 1, the image forming apparatus 100 includes first, second, third, and fourth image forming units SY, SM, SC, and SK. The image forming units SY, SM, SC, and SK form yellow (Y), magenta (M), cyan (C), and black (K) images, respectively. In the present embodiment, a configuration and an operation of each of the image forming units SY, SM, SC, and SK are common except that a color of a used toner is different. Therefore, in the following description, in a case where no particular distinction is required, Y, M, C, and K at the ends of reference numerals indicating specific colors of elements are omitted to collectively describe the elements.

The image forming unit S includes a photosensitive drum 1 that is a drum-shaped (cylindrical) electrophotographic photosensitive member (photosensitive member) that is disposed so as to be rotatable. The photosensitive drum 1 serving as an image bearing member is rotationally driven in a direction of an arrow R1 by a drive motor (not illustrated). The following process devices are disposed around the photosensitive drum 1 in a rotation direction of the photosensitive drum 1. First, a charging roller 2 is disposed. Then, starting from the charging roller 2, an exposure device 3, a developing device 4, an on-drum patch sensor 160, a pre-exposure device 140, a drum cleaning device 6, and a post-cleaning exposure device 130 are arranged in this order from an upstream side in the rotation direction. These devices are described below.

An intermediate transfer belt 7 implemented by an endless belt is disposed so as to face the respective photosensitive drums 1 of the image forming units S. The intermediate transfer belt 7 serving as an intermediate transfer member is stretched around stretching rollers such as a driving roller 71, a tension roller 72, a secondary transfer opposing roller 73, and push-up rollers 74 and 75. The driving roller 71 transmits a driving force to the intermediate transfer belt 7. The tension roller 72 applies a predetermined tension to the intermediate transfer belt 7. The secondary transfer opposing roller 73 is an opposing member (opposing electrode) of a secondary transfer roller 8 described below. The push-up rollers 74 and 75 form a primary transfer plane 70 for transferring a toner image to the intermediate transfer belt 7. Four image forming units SY, SM, SC, and SK are disposed in series along a horizontal portion of the primary transfer plane 70. The driving roller 71 is rotationally driven at a peripheral speed of 400 mm/sec by a drive motor (not illustrated) such as a pulse motor. As a result, the intermediate transfer belt 7 rotates (circulates) in a direction indicated by an arrow R2 (hereinafter, also referred to as a “rotation direction” or “conveyance direction”). The stretching rollers other than the driving roller 71 rotate following the rotation of the intermediate transfer belt 7.

On an inner peripheral surface (inner surface) side of the intermediate transfer belt 7, a roller-shaped primary transfer roller 5 serving as a transfer member is disposed at a position facing each photosensitive drum 1 of each image forming unit S. The primary transfer roller 5 is urged (pressed) toward the photosensitive drum 1 via the intermediate transfer belt 7, and forms a primary transfer portion (primary transfer nip portion) T1 where the intermediate transfer belt 7 and the photosensitive drum 1 are in contact with each other. The roller-shaped secondary transfer roller 8 is disposed at a position facing the secondary transfer opposing roller 73 on an outer peripheral surface (outer surface) side of the intermediate transfer belt 7. The secondary transfer roller 8 is urged (pressed) toward the secondary transfer opposing roller 73 via the intermediate transfer belt 7, and forms a secondary transfer portion (secondary transfer nip portion) T2 where the intermediate transfer belt 7 and the secondary transfer roller 8 are in contact with each other. The belt cleaning device 9 is disposed at a position facing the driving roller 71 on the outer peripheral surface side of the intermediate transfer belt 7.

The rotating photosensitive drum 1 is uniformly charged by the charging roller 2. The charged photosensitive drum 1 is exposed by the exposure device 3 according to image information, and an electrostatic latent image according to the image information is formed on the photosensitive drum 1. The electrostatic latent image formed on the photosensitive drum 1 is developed into a toner image when the toner of the color corresponding to each image forming unit S is supplied from the developing device 4. The toner image formed on the photosensitive drum 1 is transferred (primarily transferred) to the rotatable intermediate transfer belt 7 by an action of the primary transfer roller 5 at the primary transfer portion T1. At this time, a primary transfer bias (primary transfer voltage), which is a direct current (DC) voltage having a polarity opposite to a charging polarity (normal charging polarity) of the toner at the time of development, is applied from a primary transfer power supply 51 to the primary transfer roller 5, and a primary transfer electric field is formed at the primary transfer portion T1. In the present embodiment, the primary transfer power supplies 51Y, 51M, 51C, and 51K are connected to the primary transfer rollers 5Y, 5M, 5C, and 5K of the image forming units SY, SM, SC, and SK, respectively. For example, at the time of forming a full-color image, the toner images of the respective colors of yellow, magenta, cyan, and black formed by the respective image forming units S are sequentially transferred to the intermediate transfer belt 7 so as to be superimposed on each other at the respective primary transfer portions T1.

The toner image transferred to the intermediate transfer belt 7 can be transferred to a recording material P at the secondary transfer portion T2 by an action of the secondary transfer roller 8 serving as a secondary transfer member (secondary transfer). At this time, a secondary transfer bias (secondary transfer voltage), which is a DC voltage having a polarity opposite to the normal charging polarity of the toner, is applied from a secondary transfer power supply 81 to the secondary transfer roller 8, and a secondary transfer electric field is formed at the secondary transfer portion T2. By this time, the recording material P is sent out from a sheet feeding cassette 10, temporarily stopped by a registration roller 12, and then conveyed to the secondary transfer portion T2 at a predetermined timing. The recording material P to which the toner image has been transferred is conveyed to the fixing device 11. In the fixing device 11, the toner image is fixed to the recording material P by heat and pressure. Thereafter, the recording material P is discharged (output) to the outside of an apparatus body of the image forming apparatus 100.

Residual toner on the photosensitive drum 1 (on the image bearing member) that has not been transferred to the intermediate transfer belt 7 in a primary transfer process is removed from the photosensitive drum 1 by the drum cleaning device 6. Further, the residual toner after transfer on the intermediate transfer belt 7 (on the intermediate transfer member) that has not been transferred to the recording material P in a secondary transfer process is removed from the intermediate transfer belt 7 by the belt cleaning device 9.

### IMAGE FORMING MODE

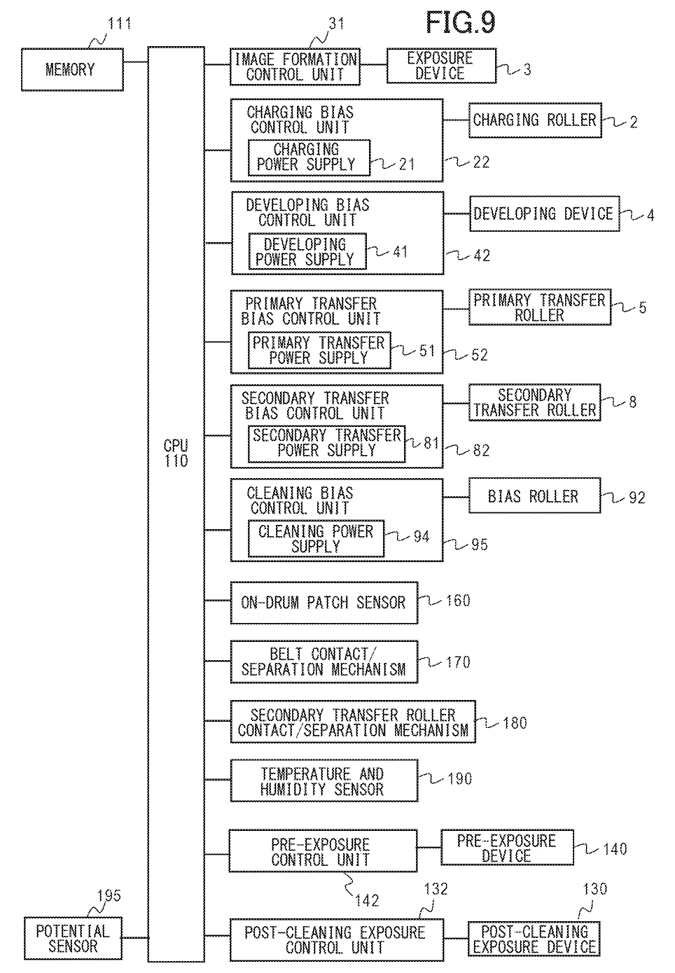

The image forming apparatus 100 of the present embodiment can execute a full-color mode and a black monochrome mode as a plurality of image forming modes in which a different number of image forming units S are used for forming the toner images. In the full-color mode, the toner images can be formed by the image forming units SY, SM, SC, and SK to form the full-color image. In the black monochrome mode, the toner image can be formed only by the image forming unit SK among the image forming units SY, SM, SC, and SK to form the black image. The image forming apparatus 100 includes a belt contact/separation mechanism 170 (see FIG. 9) that enables the photosensitive drums 1Y, 1M, and 1C of the image forming units SY, SM, and SC that are not used in the black monochrome mode to be in non-contact with the intermediate transfer belt 7.

As illustrated in FIG. 2, the belt contact/separation mechanism 170 can move the primary transfer plane 70 by moving the push-up rollers 74 and 75 and the primary transfer rollers 5Y, 5M, and 5C. In the full-color mode, the primary transfer plane 70 is formed by the push-up rollers 74 and 75 and the tension roller 72. In the black monochrome mode, the primary transfer plane 70 is formed by the push-up roller 75 and the tension roller 72 on a downstream side in the conveyance direction of the intermediate transfer belt 7. Accordingly, in the full-color mode, the photosensitive drums 1Y, 1M, 1C, and 1K are brought into contact with the intermediate transfer belt 7. On the other hand, in the black monochrome mode, the photosensitive drums 1Y, 1M, and 1C are separated from the intermediate transfer belt 7. The photosensitive drums 1Y, 1M, and 1C of the image forming units SY, SM, and SC, which are not used in the black monochrome mode, can be separated from the intermediate transfer belt 7, thereby extending lives of the photosensitive drums 1Y, 1M, and 1C.

### PHOTOSENSITIVE DRUM

The photosensitive drum 1 is formed by applying an organic photoconductor layer (OPC) to an outer peripheral surface of an aluminum cylinder. Both end portions of the photosensitive drum 1 in a longitudinal direction (rotation axis direction) are rotatably supported by flanges, and the driving force is transmitted from the drive motor (not illustrated) to one end portion, whereby the photosensitive drum 1 is rotationally driven. In the present embodiment, a charging polarity of the photosensitive drum 1 is negative. For example, an outer diameter of the photosensitive drum 1 is 80 mm.

### CHARGING ROLLER

The charging roller 2 serving as a charging unit is a contact charging member that comes into contact with a surface of the photosensitive drum 1 and uniformly charges a peripheral surface of the photosensitive drum 1. The charging roller 2 is a conductive roller in which an elastic layer is formed around a core metal (core material). Both end portions of the charging roller 2 in a longitudinal direction (rotation axis direction) are rotatably held by bearing members and are urged toward the photosensitive drum 1 by pressure springs. As a result, the charging roller 2 comes into pressure contact with the surface of the photosensitive drum 1 with a predetermined pressing force, and rotates following the rotation of the photosensitive drum 1. A charging bias (charging voltage) is applied from a charging power supply 21 (see FIG. 9) to the core metal of the charging roller 2. As a result, the peripheral surface of the rotatable photosensitive drum 1 is charged to a predetermined potential of a predetermined polarity (a negative polarity in the present embodiment). The charging bias is an oscillating voltage in which an alternating current (AC) voltage (Vac) is superimposed on a DC voltage (Vdc). More specifically, the charging bias is an oscillating voltage in which a sinusoidal AC voltage (AC component) with a frequency f of 1 kHz and a peak-to-peak voltage Vpp of 1.5 kV is superimposed on a DC voltage (DC component) of -600 V. As a result, the surface of the photosensitive drum 1 is uniformly charged to -600 V (dark potential Vd).

### EXPOSURE DEVICE

The exposure device 3 serving as an exposure unit is a laser scanner device which includes a laser light source, a polygon mirror, and the like, and of which lighting is controlled by a drive circuit according to the image information. The exposure device 3 projects a laser beam corresponding to the image information of a component color of a document, which corresponds to each image forming unit S, onto the photosensitive drum 1 via the polygon mirror or the like.

### DEVELOPING DEVICE

The developing device 4 serving as a developing unit uses a two-component developer including a non-magnetic toner and a magnetic carrier as developers. In the present embodiment, the toner is a toner having a negative charging characteristic. The developing device 4 includes a developing container that stores the developer. In the developing container, a two-component developer including a non-magnetic toner of each of colors, yellow, magenta, cyan, and black, and a magnetic carrier is stored for each developing device 4. In addition, the developing device 4 includes a developing sleeve provided so as to be partially exposed from an opening portion of the developing container, which faces the photosensitive drum 1. The developing sleeve is disposed adjacent to the surface of the photosensitive drum 1, is rotationally driven by the drive motor (not illustrated), and is applied with a developing bias (developing voltage) by a developing power supply 41 (see FIG. 9). As a result, the toner of the developer born on the developing sleeve is conveyed to a position facing the photosensitive drum 1 (a developing position) and supplied to the photosensitive drum 1, so that the electrostatic latent image on the photosensitive drum 1 is developed into a toner image. In the present embodiment, the developing device 4 forms the toner image by reverse development in which the toner having the same polarity as the charging polarity of the photosensitive drum 1 is attached to an exposed portion on the photosensitive drum 1 where an absolute value of the potential is reduced after being uniformly charged. An external additive for improving releasability of the toner is added to the toner.

### ON-DRUM PATCH SENSOR

The image forming apparatus 100 according to the present embodiment can execute an adjustment mode for adjusting a density of the toner image to be formed on the recording material P by changing an image forming condition according to a density of an adjustment toner image (referred to as a patch) formed on the photosensitive drum 1. The image forming apparatus 100 includes the on-drum patch sensor 160 for detecting the density of the patch formed on the photosensitive drum 1. The on-drum patch sensor 160 is disposed so as to detect the density of the patch on the photosensitive drum 1 at a position downstream of a position where the developing sleeve and the photosensitive drum 1 face each other and upstream of the primary transfer portion T1 in the rotation direction of the photosensitive drum 1. With such an arrangement, the on-drum patch sensor 160 can perform detection without disturbing the patch at the primary transfer portion T1.

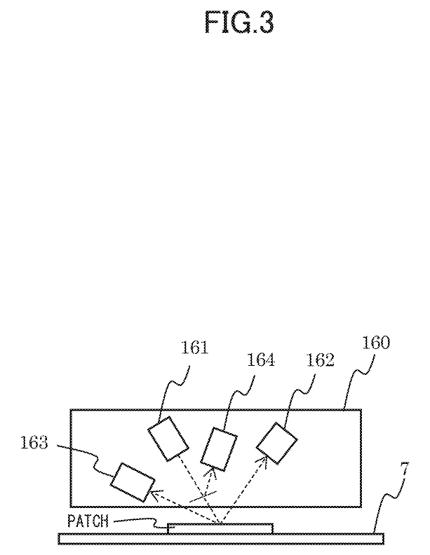

FIG. 3 is a schematic diagram illustrating a schematic configuration of the on-drum patch sensor 160. In the on-drum patch sensor 160 serving as a detection unit, an LED light source 161 irradiates light, a first photosensor 162 detects a light amount of a specular reflection component among light components reflected by the surface of the photosensitive drum 1, and a second photosensor 163 detects a light amount of a diffuse reflection component. In the present embodiment, an LED having a wavelength of 880 nm is used as the LED light source 161 of the on-drum patch sensor 160. Since the photosensitive drum 1 is exposed by the LED light source only at the time of reading the patch, it is preferable that the wavelength is in a wavelength range in which sensitivity of the photosensitive drum 1 is low when the photosensitive drum 1 is exposed, and is preferably in a near-infrared wavelength range.

### PRIMARY TRANSFER ROLLER

The primary transfer roller 5 is a conductive roller in which an elastic layer is formed around a core metal (core material). The core metal is a columnar member made of a conductive metal and having a diameter of 8 mm. The elastic layer is a conductive foam having a resistance value of 1.0 × 10⁴ to 1.0 × 10⁸ Ω and a thickness of 5 mm, and covers the core metal. In the present embodiment, an outer diameter of the primary transfer roller 5 is the same in all the image forming units S.

The primary transfer roller 5 is supported by a pressing mechanism to come into contact with the photosensitive drum 1 from an inner surface of the intermediate transfer belt 7 in order to transfer the toner image from the photosensitive drum 1 to the intermediate transfer belt 7 by an electrical action and a pressing force. In the present embodiment, both end portions of the primary transfer roller 5 in the longitudinal direction (rotation axis direction) are pressed upward in a vertical direction by pressure springs.

### PRE-EXPOSURE DEVICE

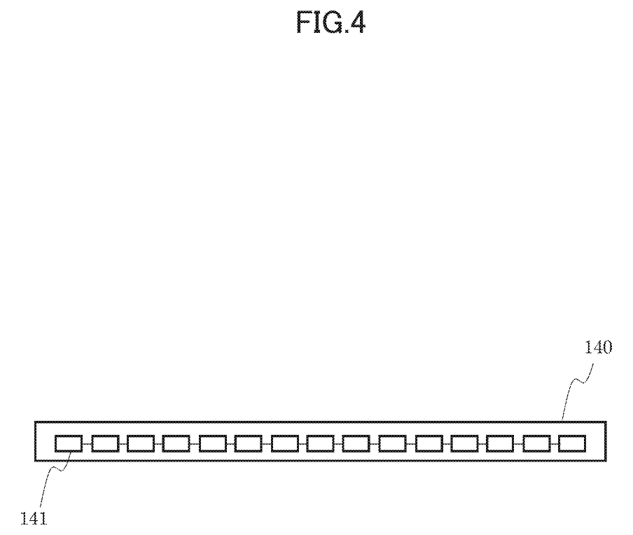

The pre-exposure device 140 is disposed downstream of the primary transfer portion T1 and upstream of the drum cleaning device 6 in the rotation direction of the photosensitive drum 1. The pre-exposure device 140 serving as a neutralization unit exposes the surface of the photosensitive drum 1 having passed through the primary transfer portion T1 to neutralize the photosensitive drum 1. As the pre-exposure device 140, an LED array, a light guide that transmits LED light, or the like can be used. FIG. 4 is a schematic diagram illustrating the pre-exposure device 140. In the present embodiment, an LED array is used as the pre-exposure device 140. As illustrated in FIG. 4, a plurality of light emitting elements 141 are arranged in the LED array (pre-exposure device 140). A light emission amount of the light emitting element 141 can be changed by a control current from a pre-exposure control unit 142 (see FIG. 9). The light emission amount of the light emitting element 141 can be increased by increasing the control current from the pre-exposure control unit 142.

### POST-CLEANING EXPOSURE DEVICE

The post-cleaning exposure device 130 is disposed downstream of the drum cleaning device 6 and upstream of the charging roller 2 in the rotation direction of the photosensitive drum 1. The post-cleaning exposure device 130 serving as a post-neutralization unit exposes the surface of the photosensitive drum 1 having passed through the drum cleaning device 6 to re-neutralize the photosensitive drum 1. As the post-cleaning exposure device 130, the same configuration as that of the pre-exposure device 140 can be used. A light emission amount of the post-cleaning exposure device 130 can be changed by a control current from a post-cleaning exposure control unit 132 (see FIG. 9).

### DRUM CLEANING DEVICE

The drum cleaning device 6 is disposed downstream of the pre-exposure device 140 and upstream of the post-cleaning exposure device 130 in the rotation direction of the photosensitive drum 1. The drum cleaning device 6 includes a cleaning blade of a plate-shaped member formed of rubber such as urethane rubber. The drum cleaning device 6 is disposed such that the cleaning blade comes into contact with the photosensitive drum 1 while maintaining a penetration depth of, for example, 1.0 mm. The cleaning blade comes into contact with the surface of the photosensitive drum 1 such that a free end portion is positioned upstream of a fixed end portion in the rotation direction of the photosensitive drum 1 (counter contact).

### INTERMEDIATE TRANSFER BELT

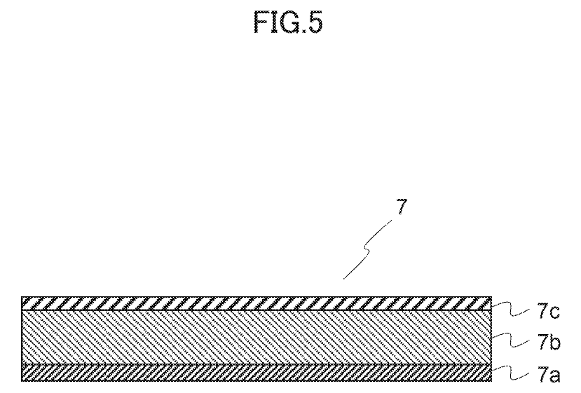

In the present embodiment, an endless belt having a plurality of layers including an elastic layer is used as the intermediate transfer belt 7. FIG. 5 is a cross-sectional view illustrating an example of a layer configuration of the intermediate transfer belt 7. In the present embodiment, the intermediate transfer belt 7 has a three-layer structure including a base layer (resin layer) 7a, an elastic layer 7b, and a surface layer 7c. The intermediate transfer belt 7 preferably has a surface resistivity of 1 × 10¹⁰ to 1 × 10¹³ Ω/□ and a volume resistivity of 1 × 10⁸ to 5 × 10¹² Ω·cm in three layers in order to maintain image quality, and in the present embodiment, the surface resistivity is 1 × 10¹² Ω/□ and the volume resistivity is 1 × 10¹¹ Ω·cm. The resistivity was measured using a high resistivity meter Hiresta-UP (MCP-HT450) and a UR probe, manufactured by Mitsubishi Chemical Group Corporation, under measurement conditions of an applied voltage of 1000 V and an application time of 10 seconds. A thickness of the base layer 7a of the intermediate transfer belt 7 is preferably about 50 μm to 100 μm, a thickness of the elastic layer 7b of the intermediate transfer belt 7 is preferably about 200 μm to 300 μm, and a thickness of the surface layer 7c of the intermediate transfer belt 7 is preferably about 2 to 20 μm. In the present embodiment, the thickness of the base layer 7a is 85 μm, the thickness of the elastic layer 7b is 260 μm, and the thickness of the surface layer 7c is 2 μm. A surface hardness in three layers of the intermediate transfer belt 7 is preferably about 40 to 90 degrees in terms of IRHD hardness, and is 73±3 degrees in the present embodiment.

The base layer 7a and the elastic layer 7b may be made of any material as long as the base layer 7a and the elastic layer 7b satisfy the characteristics as described above, and representative examples thereof include the following. As a resin material of the base layer (resin layer) 7a, for example, polycarbonate, a fluorine-based resin (ethylene tetrafluoroethylene (ETFE) or polyvinylidene fluoride (PVDF)), a polyamide resin, a polyimide resin, or the like having a Young's modulus (in accordance with JIS K 7127) of 5.0 × 10² to 5.0 × 10³ MPa can be used. As an elastic material (elastic rubber or elastomer) of the elastic layer 7b, butyl rubber, fluororubber, chloroprene (CR) rubber, ethylene-propylene diene monomer (EPDM), urethane rubber, or the like having a Young's modulus of 0.1 to 1.0 × 10² MPa can be used. In addition, a material of the surface layer 7c is not particularly limited, but it is desirable that the material reduces an adhesion force of the toner to the surface of the intermediate transfer belt 7 to improve secondary transferability. Examples of the material include a resin material such as a fluororesin or a fluorocompound having a Young's modulus of 1.0 × 10² to 5.0 × 10³ MPa, a material in which fluororesin fine particles are dispersed in a urethane-based resin, and an elastic material. However, all the base layer 7a, the elastic layer 7b, and the surface layer 7c are not limited to the above materials. As described above, in the present embodiment, the intermediate transfer member has at least a plurality of layers, and a layer on a surface side on which the toner image is born has a lower hardness than the lowermost layer on a surface side on which the toner image is not born.

In the present embodiment, the elastic intermediate transfer belt as described above is used as the intermediate transfer belt 7, but a single-layer belt such as a resin belt may also be used.

### SECONDARY TRANSFER ROLLER

The secondary transfer roller 8 is a conductive roller in which an elastic layer of ion-conductive foamed rubber (nitrile butadiene rubber (NBR), EPDM rubber, hydrin rubber, or the like) is formed around a core metal (core material). The secondary transfer roller 8 has an outer diameter of 24 mm and a surface roughness Rz of 6.0 μm to 12.0 μm. The secondary transfer roller 8 has a resistance value of 1.0 × 10⁵ to 1.0 × 10⁸ Ω measured under an N/N environment (23° C, 50%RH) with an applied voltage of 2 kV.

In the present embodiment, the image forming apparatus 100 includes a secondary transfer roller contact/separation mechanism 180 (see FIG. 9) that brings the secondary transfer roller 8 into contact with or separates the secondary transfer roller 8 from the intermediate transfer belt 7. As a result, the secondary transfer roller 8 can be selectively switched between an operating state in which the secondary transfer roller 8 comes into contact with the intermediate transfer belt 7 and rotates with the rotation of the intermediate transfer belt 7 and a non-operating state in which the secondary transfer roller 8 is separated from the intermediate transfer belt 7. The secondary transfer roller contact/separation mechanism 180 includes a support member for the secondary transfer roller 8, a switching unit for moving the secondary transfer roller via the support member, and the like. In the present embodiment, a solenoid is used as the switching unit. The secondary transfer roller contact/separation mechanism 180 serving as a movement unit moves the secondary transfer roller 8 up and down by the switching unit, so that the secondary transfer roller 8 can be moved between a contact position where the secondary transfer roller 8 comes into contact with the intermediate transfer belt 7 to form the secondary transfer portion T2 and a separation position where the secondary transfer roller 8 is separated from the intermediate transfer belt 7.

### BELT CLEANING DEVICE

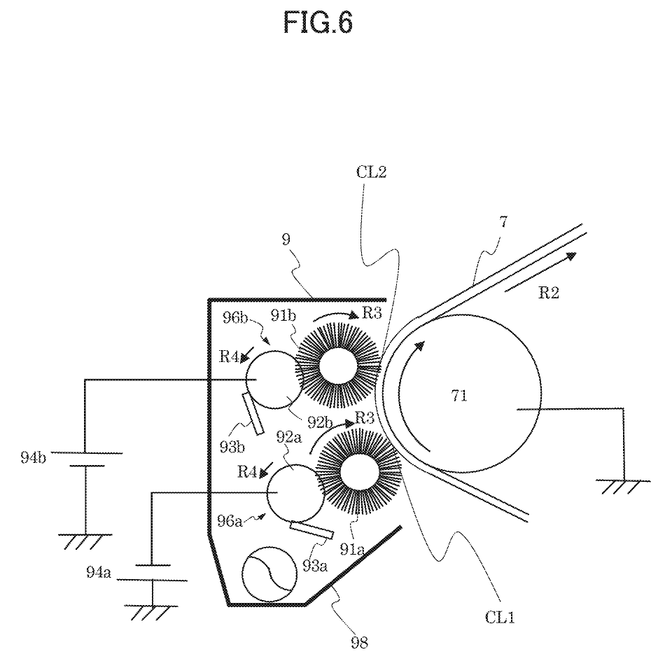

In the present embodiment, in order to remove the residual toner after transfer on the intermediate transfer belt 7 as a main purpose, the belt cleaning device 9 of an electrostatic cleaning system is used. FIG. 6 is a schematic diagram illustrating the belt cleaning device 9. The belt cleaning device 9 is disposed upstream of the primary transfer portion T1 (more specifically, the most upstream primary transfer portion T1Y) and downstream of the secondary transfer portion T2 in the conveyance direction of the intermediate transfer belt 7.

The belt cleaning device 9 includes a housing 98 disposed in the vicinity of the intermediate transfer belt 7. The belt cleaning device 9 includes, inside the housing 98, an upstream fur brush 91a disposed on an upstream side in the conveyance direction of the intermediate transfer belt 7 and a downstream fur brush 91b disposed on a downstream side. The upstream fur brush 91a and the downstream fur brush 91b are in contact with the intermediate transfer belt 7 at positions facing the driving roller 71 via the intermediate transfer belt 7, and respectively form first and second electrostatic cleaning portions CL1 and CL2 that collect the toner from the intermediate transfer belt 7. In addition, the belt cleaning device 9 includes, inside the housing 98, an upstream bias roller 92a that is in contact with the upstream fur brush 91a and a downstream bias roller 92b that is in contact with the downstream fur brush 91b. Further, the belt cleaning device 9 includes, inside the housing 98, an upstream blade 93a that is in contact with the upstream bias roller 92a and a downstream blade 93b that is in contact with the downstream bias roller 92b.

The upstream and downstream fur brushes (91a and 91b) are conductive fur brushes formed by flocking carbon-dispersed nylon fibers having a yarn resistance value of 1 × 10¹⁰ Ω/cm and a fiber thickness of 2 deniers on a metal roller (core material) at a flocking density of 240,000 fibers/inch². In the present embodiment, the upstream and downstream fur brushes (91a and 91b) have a diameter of 21 mm. The upstream and downstream bias rollers (92a and 92b) are formed of metal rollers made of aluminum. In the present embodiment, the upstream and downstream bias rollers (92a and 92b) have a diameter of 20 mm. The upstream and downstream blades (93a and 93b) are formed of a plate-shaped member made of urethane rubber. As described above, in the present embodiment, an upstream cleaning member 96a includes the upstream fur brush 91a, the upstream bias roller 92a, and the upstream blade 93a. A downstream cleaning member 96b includes the downstream fur brush 91b, the downstream bias roller 92b, and the downstream blade 93b. The upstream and downstream cleaning members (96a and 96b) are arranged in parallel in the conveyance direction of the intermediate transfer belt 7.

The upstream and downstream fur brushes (91a and 91b) are disposed so as to be in sliding contact with the intermediate transfer belt 7 while maintaining a penetration depth of about 1.5 mm with respect to the intermediate transfer belt 7. The upstream and downstream fur brushes (91a and 91b) are rotationally driven in a direction of an arrow R3 at a speed (peripheral speed) of 150 mm/sec by a drive motor (not illustrated). The movement direction indicated by the arrow R3 is a direction opposite to the movement direction of the intermediate transfer belt 7 at the first and second electrostatic cleaning portions CL1 and CL2. The upstream and downstream bias rollers (92a and 92b) are disposed while maintaining a penetration depth of about 2.0 mm with respect to the upstream and downstream fur brushes (91a and 91b). The upstream and downstream bias rollers (92a and 92b) are rotationally driven in a direction of an arrow R4 at a speed (peripheral speed) equivalent to that of the upstream and downstream fur brushes (91a and 91b) by the drive motor (not illustrated). The movement direction indicated by the arrow R4 is the same direction as the movement direction of the upstream and downstream fur brushes (91a and 91b) at contact portions with the upstream and downstream fur brushes (91a and 91b). The upstream and downstream blades (93a and 93b) are disposed while maintaining a penetration depth of 1.0 mm with respect to the upstream and downstream bias rollers (92a and 92b). The upstream and downstream blades (93a and 93b) are in contact with the upstream and downstream bias rollers (92a and 92b) such that a free end is positioned upstream of a fixed end in a rotation direction of the upstream and downstream bias rollers (92a and 92b) (counter contact).

A negative DC voltage is applied to the upstream bias roller 92a as a cleaning bias from a first cleaning power supply 94a. Further, a positive DC voltage is applied to the downstream bias roller 92b as a cleaning bias from a second cleaning power supply 94b. The first and second cleaning power supplies (94a and 94b) apply the cleaning biases under constant current control to correspond to potentials of the intermediate transfer belt 7 and the upstream and downstream fur brushes (91a and 91b) under various conditions. As a current value of the cleaning bias, a current value suitable for cleaning the residual toner after transfer on the intermediate transfer belt 7 is stored in advance in a memory 111 (see FIG. 9 described below) or the like.

An operation in the case of cleaning the residual toner after transfer on the intermediate transfer belt 7 will be described. By applying the negative cleaning bias (-) to the upstream bias roller 92a, a potential difference is generated between the intermediate transfer belt 7 and the upstream fur brush 91a. As a result, the toner charged to a positive polarity (+) in the residual toner after transfer on the intermediate transfer belt 7 is adsorbed and transferred to the upstream fur brush 91a. The toner adsorbed and transferred to the upstream fur brush 91a is transferred from the upstream fur brush 91a to the upstream bias roller 92a by a potential difference between the upstream fur brush 91a and the upstream bias roller 92a. Then, the toner transferred to the upstream bias roller 92a is scraped off from the upstream bias roller 92a by the upstream blade 93a and stored in a collected toner storage portion formed in the housing 98.

Even if the residual toner after transfer on the intermediate transfer belt 7 is cleaned by the upstream cleaning member 96a, a toner having no polarity or a toner charged to a negative polarity (-) remains on the intermediate transfer belt 7. Such toners are charged to a negative polarity (-) by the negative cleaning bias (-) applied to the upstream fur brush 91a. Such charging is considered to be performed by charge injection or discharge.

The toners can be adsorbed and transferred to the downstream fur brush 91b by applying the positive cleaning bias (+) to the downstream bias roller 92b to generate a potential difference between the intermediate transfer belt 7 and the downstream fur brush 91b. The toners adsorbed and transferred to the downstream fur brush 91b are transferred from the downstream fur brush 91b to the downstream bias roller 92b due to a potential difference between the downstream fur brush 91b and the downstream bias roller 92b. Then, the toners transferred to the downstream bias roller 92b are scraped off from the downstream bias roller 92b by the downstream blade 93b. In this way, the residual toner after transfer on the intermediate transfer belt 7 can be removed.

### PATCH

Next, the patch formed when the adjustment mode is executed will be described. When the adjustment mode is executed, the patch formed on the photosensitive drum 1 is detected by the on-drum patch sensor 160 before reaching the primary transfer portion T1. Densities of yellow, magenta, and cyan patches are respectively detected by on-drum patch sensors 160Y, 160M, and 160C using the light amount of the diffuse reflection component. A density of a black patch is detected by an on-drum patch sensor 160K using the light amount of the specular reflection component (see FIG. 1). Then, an exposure amount by each of the exposure devices 3Y, 3M, 3C, and 3K is changed based on a detection result, whereby the density of the toner image to be formed on the recording material P is adjusted.

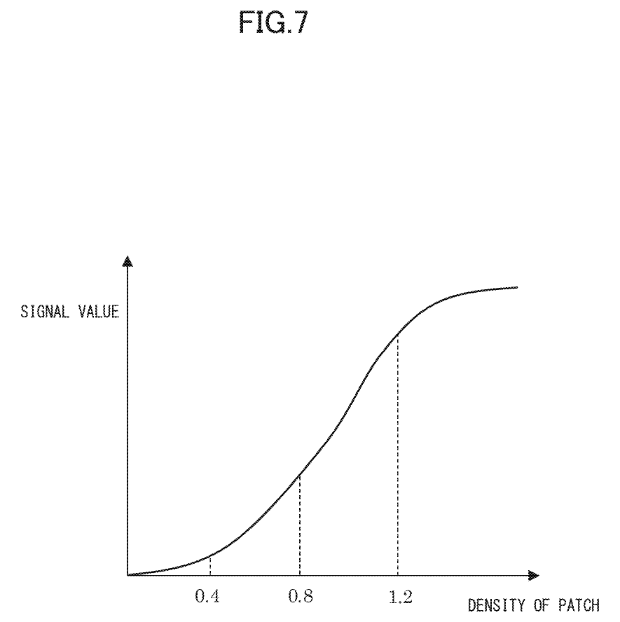

FIG. 7 is a graph illustrating behavior of a signal value of the specular reflection component of the on-drum patch sensor 160 with respect to the density of the patch. When the density of the patch is optically detected, the light amount of specular reflection decreases as the density of the patch increases. Therefore, in FIG. 7, a difference between the light amount of specular reflection on the surface of the photosensitive drum 1 and the light amount of specular reflection at the time of detecting the patch is illustrated as the signal value on a vertical axis.

As illustrated in FIG. 7, in a high density range exceeding a certain density range, saturation behavior is observed in which the signal value does not linearly increase even when the density of the patch increases. The following reasons are conceivable. That is, in order to form the toner image, toner particles are layered on the photosensitive drum 1 corresponding to the electrostatic latent image to form the image. However, when a large amount of toner is layered to increase the density and a plurality of layers are stacked, there is no large variation in an amount of reflected light. In addition, even in the case of a patch with a very low density, linearity of the signal value with respect to the density of the patch is low. The following reasons are conceivable. That is, when forming a patch image with a very low density, in a case where the toner corresponding to the electrostatic latent image is layered, only the toner particles are sparsely arranged. On the other hand, since the on-drum patch sensor 160 detects the amount of reflected light in a detection range of several millimeters, the on-drum patch sensor 160 is affected by the surface of the photosensitive drum 1. For the above reason, in the present embodiment, five gradations, which are input signal values of 20, 64, 128, 192, and 255 in 8 bits, are targeted for the density of the patch image so as to widely cover the density of the patch image.

### PATCH SHAPE

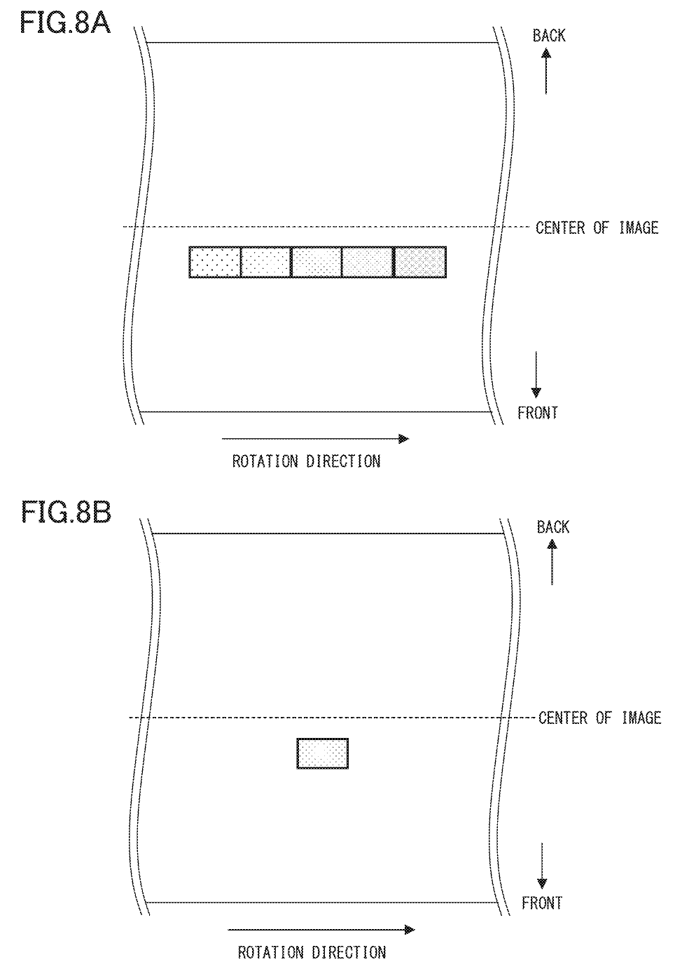

FIG. 8A is a schematic diagram illustrating an example of the patch used in the adjustment mode period. A side of the image forming apparatus 100, which corresponds to a near side of the paper in FIG. 1, is referred to as a front side, and a side opposite thereto is referred to as a back side. A depth direction connecting the front side and the back side corresponds to the longitudinal direction (main scanning direction) of the photosensitive drum 1.

In the adjustment mode period (second mode period), as illustrated in FIG. 8A, the patch including the patch image of each of the colors of black, magenta, cyan, and yellow is used for each of the photosensitive drums 1K, 1M, 1C, and 1Y. As described above, the patch images of the respective colors include five patch images continuously formed in the rotation direction of the photosensitive drum 1, each of which has five gradations that are input signal values of 32, 96, 128, 192, and 255 in 8 bits. In addition, in a case where the image density adjustment is performed for different screens, a total of 10 patch images may be formed by continuously forming two types of the five patch images for each color. A size of one patch image is, for example, 25 mm in the rotation direction of the photosensitive drum 1, and 12 mm in the main scanning direction (a direction intersecting the rotation direction). The size of the patch image may be any size as long as the density can be detected by the on-drum patch sensor 160. For example, a patch including 10 patch images may be formed, and in this case, a length of the patch in the rotation direction of the photosensitive drum 1 is 250 mm (25 × 10).

Although the patch used in the adjustment mode period has been described above, an automatic toner replenishment (ATR) patch used to detect toner developability may be formed in ATR control.

In the present embodiment, the two-component developer containing the non-magnetic toner and the magnetic carrier as main components is used as the developer. As is well known, a T/D ratio (a ratio of a toner weight to a total weight of the carrier and the toner) of the two-component developer and a toner charging amount are important factors in stabilizing the image quality. The toner of the developer is consumed at the time of development, the T/D ratio of the developer decreases, and at the same time, the toner charging amount increases, as a result of which an image density decreases. Therefore, the ATR control is performed in which a concentration of the developer or the image density is detected at an appropriate timing, the toner is replenished from a toner bottle according to such a change, and the T/D ratio or the image density is controlled to be as constant as possible to maintain the image quality.

FIG. 8B is a schematic diagram illustrating an example of the ATR patch for the ATR control. The number of patch images of the ATR patch formed in one ATR control may be one, and the size of the patch image may be 25 mm × 12 mm, which is the same as that in the above-described adjustment mode period. The ATR patch is preferably a halftone density patch pattern, and for example, a patch having an input signal value of 96 in a density signal of 8 bits is used.

### CONTROL SYSTEM

Next, a control system of the image forming apparatus 100 will be described with reference to FIG. 9. Although various devices are connected to a central processing unit (CPU) 110 in addition to those illustrated in FIG. 9, illustration and description thereof are omitted here because it is not the gist of disclosure.

As illustrated in FIG. 9, the image forming apparatus 100 includes the CPU 110 serving as a control unit that integrally controls the image forming apparatus 100, and a memory 111 such as a read only memory (ROM) and a random access memory (RAM). The RAM stores a sensor detection result, a computation result, and the like, and the ROM stores a control program, a data table obtained in advance, and the like. An image formation control unit 31, a charging bias control unit 22, a developing bias control unit 42, a primary transfer bias control unit 52, a secondary transfer bias control unit 82, a cleaning bias control unit 95, a pre-exposure control unit 142, and a post-cleaning exposure control unit 132, which operate under the control of the CPU 110, are connected to the CPU 110. Although not illustrated, the CPU 110 receives the image information from a document reading apparatus that reads an image of a document or an external device (for example, a personal computer) and controls each of the devices described above. In addition, the on-drum patch sensor 160, the belt contact/separation mechanism 170, the secondary transfer roller contact/separation mechanism 180, a temperature and humidity sensor 190, a potential sensor 195, and the like are connected to the CPU 110.

The image formation control unit 31 controls an exposure timing of the exposure device 3 or the like. The photosensitive drum 1 during image formation is rotated at a predetermined rotational speed. Therefore, a time from when the photosensitive drum 1 is exposed by the exposure device 3 to form the electrostatic latent image to when the toner image is primarily transferred to the intermediate transfer belt 7 is constant. The image formation control unit 31 controls the exposure timing of the exposure device 3 for the photosensitive drum 1 to adjust an image formation timing or a patch formation timing. In the present embodiment, the patch formation timing on the photosensitive drum 1 is controlled such that the patch is formed on the photosensitive drum 1 every predetermined number of sheets (for example, 200 sheets). In addition, the image formation control unit 31 controls the next image formation timing on the photosensitive drum 1 to an appropriate timing when the cleaning for the patch on the photosensitive drum 1 is completed.

The charging bias control unit 22 can output a voltage obtained by superimposing an AC voltage on a DC voltage from the charging power supply 21 to the charging roller 2. The developing bias control unit 42 can output a voltage obtained by superimposing an AC voltage on a DC voltage from the developing power supply 41 to the developing device 4. In addition, the primary transfer bias control unit 52 can output a voltage subjected to constant current control and a voltage subjected to constant voltage control from the primary transfer power supply 51 to the primary transfer roller 5. That is, the primary transfer bias control unit 52 includes a current detection unit that detects a current value flowing when a voltage is applied to the primary transfer roller 5, and a voltage detection unit that detects an output voltage value. Then, the primary transfer bias control unit 52 can perform constant current control and constant voltage control of the bias applied to the primary transfer roller 5 by feeding back a detection result to the CPU 110. The secondary transfer bias control unit 82 is similar to the primary transfer bias control unit 52.

In the present embodiment, the toner image is transferred from the photosensitive drum 1 to the intermediate transfer belt 7 by setting the primary transfer bias applied to the primary transfer roller 5 of the image forming unit S to a positive bias having a polarity opposite to the normal charging polarity of the toner in a normal image formation period. In the normal image formation period, the secondary transfer bias applied to the secondary transfer roller 8 is set to a positive secondary transfer bias having a polarity opposite to the normal charging polarity of the toner, whereby the toner image is transferred from the intermediate transfer belt 7 to the recording material P. In the present specification, the normal image formation period (first mode period) refers to a period in which the toner image to be formed on the recording material P other than the patch image is formed.

The cleaning bias control unit 95 can output a voltage subjected to constant current control from the cleaning power supply 94 to the bias roller 92. That is, the cleaning bias control unit 95 includes a current detection unit that detects a current value flowing when a voltage is applied to the bias roller 92. Then, the cleaning bias control unit 95 can perform constant current control of the bias applied to the bias roller 92 by feeding back the detection result to the CPU 110.

The pre-exposure control unit 142 controls the light emission amount by controlling a current applied to the pre-exposure device 140. The post-cleaning exposure control unit 132 controls the light emission amount by controlling a current applied to the post-cleaning exposure device 130. In addition, the CPU 110 sets the charging bias and the primary transfer bias to predetermined values according to an absolute moisture amount computed based on a temperature and a humidity detected by the temperature and humidity sensor 190. The potential sensor 195 detects a surface potential (dark potential) of the photosensitive drum 1.

Hitherto, in the adjustment mode period, the patch formed on the photosensitive drum 1 is not transferred to the intermediate transfer belt 7 after the density is detected by the on-drum patch sensor 160, passes through the pre-exposure device 140, and is removed by the drum cleaning device 6. However, in a case where the patch is pre-exposed by the pre-exposure device 140, there is a possibility that the toner scatters from the patch.

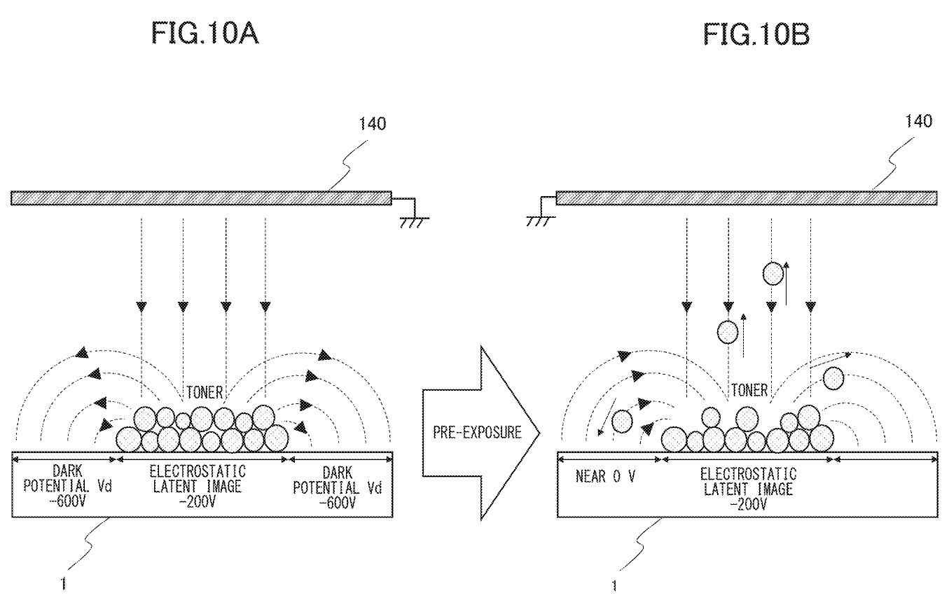

Here, a phenomenon that the toner scatters from the patch by the pre-exposure will be described with reference to FIGS. 10A and 10B. FIG. 10A illustrates a state of the patch before the pre-exposure, and FIG. 10B illustrates a state of the patch during the pre-exposure.

As illustrated in FIG. 10A, the toner of the patch formed on the photosensitive drum 1 is electrostatically restrained by lines of electric force generated between the dark potential Vd (-600 V) and the electrostatic latent image (-200 V). Before the pre-exposure, the lines of electric force are directed from the electrostatic latent image (-200 V) to the dark potential Vd (-600 V). When the patch is pre-exposed by the pre-exposure device 140, as illustrated in FIG. 10B, the dark potential Vd is neutralized to 0 V, and the direction of the line of electric force becomes opposite to the direction before the pre-exposure. As a result, the toner is released from the electrostatic restraint, and a part of the toner scatters from the patch in a direction from the photosensitive drum 1 toward the pre-exposure device 140 according to a potential difference between the pre-exposure device 140 and the photosensitive drum 1.

### DENSITY ADJUSTMENT PROCESSING

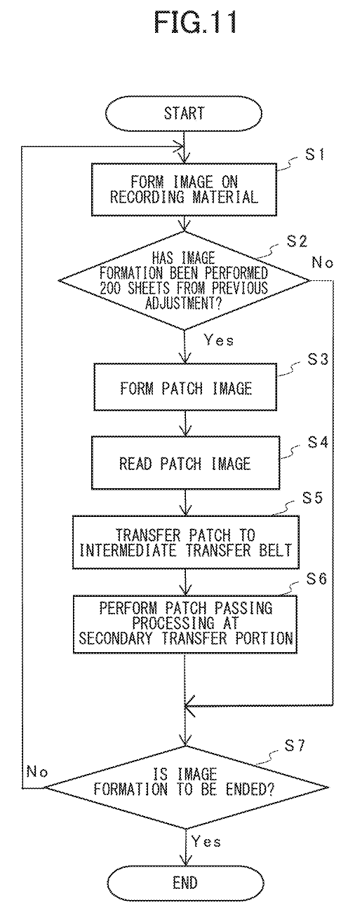

In view of the above, in the present embodiment, the patch after the density detection by the on-drum patch sensor 160 is transferred from the photosensitive drum 1 to the intermediate transfer belt 7 in the adjustment mode period. Since the patch is transferred to the intermediate transfer belt 7, the patch does not pass through the pre-exposure device 140, so that it is possible to suppress the toner scattering from the patch due to the pre-exposure. The patch transferred to the intermediate transfer belt 7 is removed by the belt cleaning device 9 serving as a cleaning unit. Hereinafter, the adjustment mode of the present embodiment will be described using FIGS. 11-13 with reference to FIGS. 1 and 9. FIG. 11 is a flowchart illustrating density adjustment processing according to the present embodiment. The adjustment mode is executed in a non-image formation period other than an image formation period in which an image is formed on the recording material P.

Here, the image forming apparatus 100 performs an image formation job which is a series of image output operations of forming and outputting an image on one or more recording materials P, the image formation job being started according to a start instruction. The image formation job generally includes an image forming process, a pre-rotation process, an inter-sheet process in the case of forming an image on a plurality of recording materials P, and a post-rotation process. The image forming process is a period in which an electrostatic latent image of an image to be actually formed and output on the recording material P is formed, a toner image is formed, and the toner image is transferred, and the image formation period refers to this period. The pre-rotation process is a period in which a preparation operation before the image forming process is performed from the input of the start instruction to the actual start of image formation. The inter-sheet process is a period corresponding to an interval between one recording material P and the next recording material P during continuous image formation for continuously forming images on a plurality of recording materials P. The post-rotation process is a period in which a reorganization operation (preparation operation) after the image forming process is performed. The non-image formation period is a period other than the image formation period, and includes the pre-rotation process, the inter-sheet process, and the post-rotation process, and further includes a pre-multi-rotation process which is a preparation operation when the image forming apparatus 100 is turned on or recovered from a sleep state. Here, in order to facilitate understanding of the description, a case where the adjustment mode is executed in the inter-sheet process will be described as an example.

As illustrated in FIG. 11, the CPU 110 performs the image forming process of forming an image on the recording material P (S1). The CPU 110 counts the number of recording materials P on which image formation has been performed, and determines whether or not image formation has been performed on a predetermined number (for example, 200) of recording materials P from the end of the previous density adjustment processing (S2). In a case where image formation has not been performed on the predetermined number of recording materials P (No in S2), the CPU 110 jumps to the processing in step S7. On the other hand, in a case where image formation has been performed on the predetermined number of recording materials P (Yes in S2), the CPU 110 forms, for example, the patch as illustrated in FIG. 8A on the photosensitive drum 1 (S3). The CPU 110 acquires the density of the patch formed on the photosensitive drum 1 and detected by the on-drum patch sensor 160 (S4).

Then, the CPU 110 applies a positive bias to the primary transfer roller 5 at least while the patch passes through the primary transfer portion T1, and transfers the patch from the photosensitive drum 1 to the intermediate transfer belt 7 (S5). In addition, the CPU 110 performs patch passing processing such that the patch transferred to the intermediate transfer belt 7 passes through the secondary transfer portion T2 and reaches the belt cleaning device 9 (S6). As an example of the patch passing processing, the CPU 110 applies a secondary transfer reverse bias having the same polarity as the normal charging polarity of the toner to the secondary transfer roller 8 at least while the patch passes through the secondary transfer portion T2.

The CPU 110 determines whether or not to end the image formation (S7). In a case where it is determined to end the image formation (Yes in S7), the CPU 110 ends the density adjustment processing. On the other hand, in a case where it is determined not to end the image formation (No in S7), the CPU 110 returns to the processing of step S1 to restart the image formation on the recording material P, and repeats the processing of steps S1 to S7.

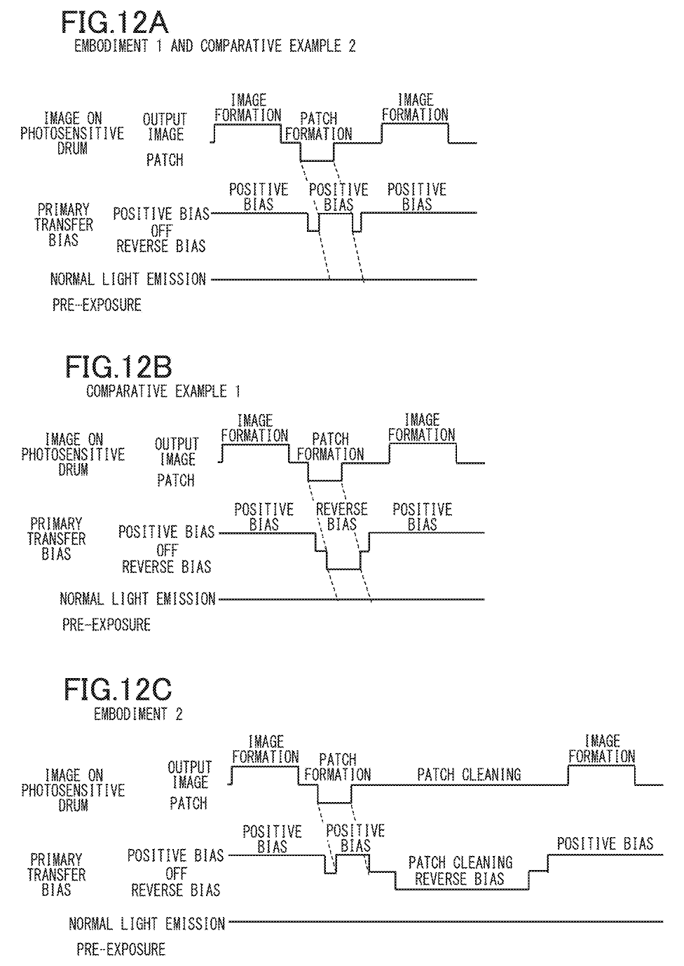

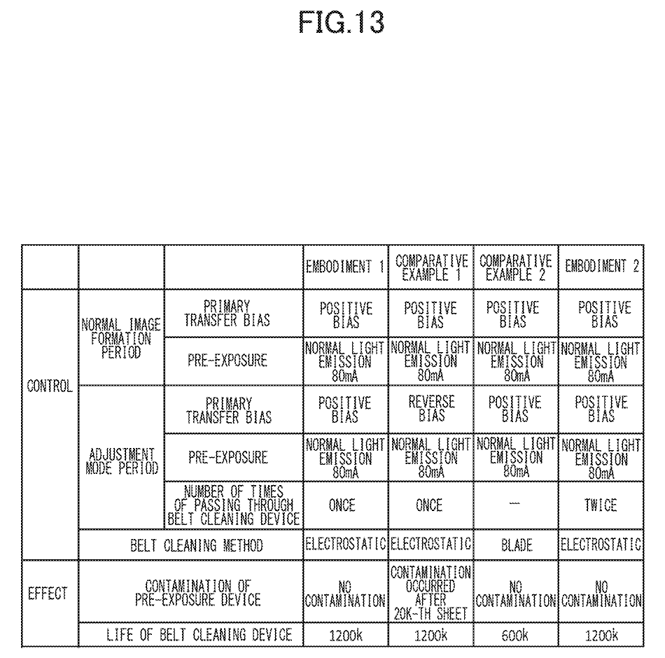

Next, effects obtained in the present embodiment will be briefly described with reference to comparative examples. FIGS. 12A-12C are diagrams illustrating sequences (operation order) of Embodiment 1, Comparative Example 2, Comparative Example 1, and Embodiment 2 with a horizontal axis as time. FIG. 13 is a diagram illustrating an effect obtained in each of Embodiment 1, Comparative Example 1, Comparative Example 2, and Embodiment 2. As can be understood from FIG. 13, a control condition in the adjustment mode period is different between Embodiment 1, Comparative Example 1, Comparative Example 2, and Embodiment 2. FIG. 13 also illustrates the control condition in the normal image formation period such that a difference from the control condition in the adjustment mode period can be seen. The control condition of the pre-exposure is indicated by a control current value from the pre-exposure control unit 142 (see FIG. 9). In any of Embodiment 1, Comparative Example 1, Comparative Example 2, and Embodiment 2, the control condition of the pre-exposure is the same in the adjustment mode period and the normal image formation period.

As illustrated in FIGS. 13 and 12A, in Embodiment 1, as described above, the primary transfer bias is set to a positive bias in the adjustment mode period. By setting the primary transfer bias to a positive bias, the patch is transferred to the intermediate transfer belt 7 and is not subjected to the pre-exposure by the pre-exposure device 140, so that toner scattering from the patch due to the pre-exposure is suppressed. Therefore, the pre-exposure device 140 is not contaminated as illustrated in Embodiment 1 of FIG. 13.

As illustrated in FIGS. 13 and 12B, in Comparative Example 1, the primary transfer bias is a positive bias in the image formation period, and is a reverse bias in the adjustment mode period, which is different from that in the image formation period. In this case, since the patch is not transferred to the intermediate transfer belt 7 and is subjected to the pre-exposure by the pre-exposure device 140, the pre-exposure device 140 was contaminated after image formation was performed on 20k recording materials P as illustrated in Comparative Example 1 of FIG. 13.

As illustrated in FIG. 13, in Comparative Example 2, the control condition in the adjustment mode period is the same as that in Embodiment 1. Therefore, as illustrated in FIG. 12A, the sequence of Comparative Example 2 is the same as the sequence of Embodiment 1. Therefore, since the patch is transferred to the intermediate transfer belt 7, the pre-exposure device 140 is not contaminated as illustrated in Comparative Example 2 in FIG. 13. However, Comparative Example 2 is a case where a blade-type belt cleaning device is used. The blade-type belt cleaning device removes the toner from the intermediate transfer belt 7 by bringing a plate-shaped cleaning blade into contact with the surface of the intermediate transfer belt 7. In Comparative Example 2, the life of the belt cleaning device is 600k sheets, which is half the case of Embodiment 1 (1200k sheets) using the electrostatic belt cleaning device 9. This is because the cleaning blade comes into contact with the surface of the intermediate transfer belt 7 to remove the toner, and thus durability is generally low, and when the number of rotations of the intermediate transfer belt 7 increases with the normal image formation, blade chipping may occur at about 600k sheets.

As illustrated in FIGS. 13 and 12C, Embodiment 2 is different from Embodiment 1 in that a patch cleaning time in the adjustment mode period is lengthened. That is, in Embodiment 2, in order to cause the electrostatic belt cleaning device 9 to remove the patch formed with a large amount of toner, the patch is passed through the belt cleaning device 9 a plurality of times (here, twice [2]). In this case, as illustrated in Embodiment 2 of FIG. 13, the patch is transferred to the intermediate transfer belt 7, and thus, the pre-exposure device 140 is not contaminated. Then, since the patch is removed in two steps by the belt cleaning device 9, the amount of toner removed in one step is limited, and a cleaning failure does not occur in the belt cleaning device 9. However, since the patch is passed through the belt cleaning device 9 a plurality of times, a time required for the adjustment mode becomes long, and productivity of the image forming apparatus 100 is deteriorated as compared with Embodiment 1. The productivity of the image forming apparatus 100 is represented by the number of images formed on the recording material P per unit time.

As described above, in the present embodiment, in the adjustment mode period, the primary transfer bias is set to a positive bias, and the patch after the density detection by the on-drum patch sensor 160 is transferred from the photosensitive drum 1 to the intermediate transfer belt 7. As the patch is transferred to the intermediate transfer belt 7, the patch does not pass through the pre-exposure device 140, and the patch is not pre-exposed by the pre-exposure device 140. Since the patch is not pre-exposed, toner scattering from the patch due to the pre-exposure is suppressed, and there is no possibility that the toner adheres to and contaminates the photosensitive drum 1, the pre-exposure device 140, or the like.

### OTHER EMBODIMENTS

In the patch passing processing (see S6 in FIG. 11) described above, the secondary transfer reverse bias is applied to the secondary transfer roller 8 so that the patch transferred to the intermediate transfer belt 7 can pass through the secondary transfer portion T2, but the present technology is not limited thereto. For example, at the time of execution of the adjustment mode, before the patch transferred to the intermediate transfer belt 7 passes through the secondary transfer portion T2, the secondary transfer roller 8 may be moved from the contact position where the secondary transfer roller 8 is brought into contact with the intermediate transfer belt 7 to the separation position where the secondary transfer roller 8 is separated from the intermediate transfer belt 7. In this case, a retraction time for retracting the secondary transfer roller 8 to the separation position may be determined based on, for example, the density (predetermined condition) of the patch.

That is, information regarding the density of the patch formed on the photosensitive drum 1 may be acquired, and the retraction time of the secondary transfer roller 8 may be determined based on whether or not the density of the patch is equal to or lower than a predetermined value. In the present embodiment, the density of the patch detected by the on-drum patch sensor 160 may be acquired as the information regarding the density of the patch, or a value predicted according to a use environment or durable use may be used.

In a case where the density of the patch is equal to or lower than the predetermined value, that is, in a case where a predetermined condition is satisfied, the amount of toner of the patch transferred to the intermediate transfer belt 7 is small. Therefore, when the patch is passed through the belt cleaning device 9 once (first number of times), the patch can be sufficiently removed from the intermediate transfer belt 7. In this case, the secondary transfer roller 8 may be retracted to the separation position until the patch passes through the belt cleaning device 9 once.

On the other hand, in a case where the density of the patch is higher than the predetermined value, that is, in a case where the predetermined condition is not satisfied, the amount of toner of the patch transferred to the intermediate transfer belt 7 increases. In this case, there is a possibility that the patch cannot be sufficiently removed from the intermediate transfer belt 7 even when the patch is passed through the belt cleaning device 9 once. Therefore, in a case where the density of the patch is higher than the predetermined value, the patch is passed through the belt cleaning device 9 twice [2] (second number of times). By doing so, the patch can be sufficiently removed from the intermediate transfer belt 7. As described above, in a case where the amount of toner of the patch is large, the secondary transfer roller 8 is retracted to the separation position until the patch passes through the belt cleaning device 9 twice [2]. That is, in a case where the amount of toner of the patch is large, the retraction time of the secondary transfer roller 8 is made longer than that in a case where the amount of toner of the patch is small. The first number of times and the second number of times are not limited to once and twice [2], respectively, and as long as the second number of times is larger than the first number of times, the first number of times and the second number of times can be any number of times.

In the above-described embodiment, an example in which the above-described adjustment mode is applied in the case of the full-color mode has been described, but the above-described adjustment mode may be applied also in the case of the black monochrome mode to suppress toner scattering from the patch due to the pre-exposure. In addition, the full-color printer including the plurality of image forming units SY to SK has been described as an example, but the present technology is not limited thereto, and for example, the above-described adjustment mode may also be applied to a monochrome printer including only a black monochrome image forming unit SK.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-062173, filed Apr. 4, 2025 which is hereby incorporated by reference herein in its entirety.

What is claimed is:

1. An image forming apparatus configured to form an image on a recording material, the image forming apparatus comprising:
a rotatable image bearing member;
a charging unit configured to charge the image bearing member;
an exposure unit configured to expose the charged image bearing member to form an electrostatic latent image;
a developing unit configured to develop the electrostatic latent image formed on the image bearing member into a toner image at a developing position;
an intermediate transfer member configured to receive the toner image from the image bearing member and transfer the toner image to the recording material;
a transfer member configured to form a primary transfer portion for transferring the toner image formed on the image bearing member to the intermediate transfer member and transfer the toner image on the image bearing member to the intermediate transfer member by application of a transfer voltage;
a detection unit configured to detect a density of an adjustment toner image formed on the image bearing member at a position downstream of the developing position and upstream of the primary transfer portion in a rotation direction of the image bearing member;
a neutralization unit configured to neutralize a surface of the image bearing member by irradiating light at a position downstream of the primary transfer portion in the rotation direction and upstream of the charging unit in the rotation direction;
a cleaning unit configured to remove toner on the intermediate transfer member at a position upstream of the primary transfer portion and downstream of a secondary transfer portion for transferring the toner image from the intermediate transfer member to the recording material in a rotation direction of the intermediate transfer member; and
a control unit configured to execute a first mode in which the toner image formed on the image bearing member is transferred to the intermediate transfer member and is transferred from the intermediate transfer member to the recording material and a second mode in which the adjustment toner image is formed on the image bearing member and detected by the detection unit,
wherein the control unit is configured to apply a transfer voltage having a polarity opposite to a normal charging polarity of the toner to the transfer member at least while the adjustment toner image passes through the primary transfer portion, transfer the adjustment toner image to the intermediate transfer member, and rotate the intermediate transfer member such that the transferred adjustment toner image passes through the cleaning unit, during execution of the second mode.

2. The image forming apparatus according to claim 1, further comprising a secondary transfer member configured to form the secondary transfer portion and transfer the toner image by application of a secondary transfer voltage,
wherein the control unit is configured to apply a transfer voltage having the same polarity as the normal charging polarity of the toner to the secondary transfer member at least while the adjustment toner image passes through the secondary transfer portion, during the execution of the second mode.

3. The image forming apparatus according to claim 1, further comprising:
a secondary transfer member configured to form the secondary transfer portion and transfer the toner image by application of a secondary transfer voltage; and
a movement unit configured to move the secondary transfer member between a contact position where the secondary transfer member comes into contact with the intermediate transfer member to form the secondary transfer portion and a separation position where the secondary transfer member is separated from the intermediate transfer member,
wherein the control unit is configured to move the secondary transfer member from the contact position to the separation position at least while the adjustment toner image passes through the secondary transfer portion, during the execution of the second mode.

4. The image forming apparatus according to claim 3, wherein
the control unit is configured
to retract, in a case where a predetermined condition is satisfied, the secondary transfer member to the separation position after the adjustment toner image is transferred to the intermediate transfer member and until the transferred adjustment toner image passes through the cleaning unit a first number of times, and
to retract, in a case where the predetermined condition is not satisfied, the secondary transfer member to the separation position until the transferred adjustment toner image passes through the cleaning after the adjustment toner image is transferred to the intermediate transfer member and unit a second number of times larger than the first number of times, during the execution of the second mode.

5. The image forming apparatus according to claim 4, wherein
the control unit is configured to acquire information regarding a density of the adjustment toner image formed on the image bearing member, and
the case where the predetermined condition is satisfied is a case where the acquired density of the adjustment toner image is equal to or lower than a predetermined value.
